(19) United States
(12) Patent Application Publication
(10) Pub. No.: US 2024/0049657 A1
(43) Pub. Date: Feb. 15, 2024

(54) TREE STUMP GRINDER

(71) Applicant: MULTI-TIP DESIGNS LIMITED, Oxfordshire (GB)

(72) Inventor: Patrick WATTS, Oxfordshire (GB)

(21) Appl. No.: 18/259,471

(22) PCT Filed: Dec. 29, 2021
(86) PCT No.: PCT/GB2021/053441

§ 371 Date: Jun. 27, 2023

(30) Foreign Application Priority Data
Dec. 29, 2020 (GB) 2020690.0

(51) Int. Cl. A01G 23/06

(52) U.S. Cl. CPC A01G 23/067

(57) ABSTRACT

A tooth assembly for use in a grinding wheel, the tooth assembly comprising a holder for holding at least one tooth within a slot of the grinding wheel, wherein the at least one tooth comprises a tooth body, wherein the at least one tooth is removably attached to the holder by attachment means comprising a recess within the tooth body and a fixing receivable in the recess.

The present invention relates to tree stump grinding machines and particularly to the grinding wheel of such a machine and the associated mechanism of engaging a tooth with the grinding wheel.

It is known in the prior art to provide a tree stump grinding machine with a cutting wheel driven by a belt, a chain, shafts or hydraulic motors. Such machines are sometimes referred to as cutting machines. Current tree stump grinding machines typically consist of a circular wheel with a number of receiving brackets positioned around the rim. The receiving brackets have channels into which are fitted individual cutting teeth. Each tooth is individually mounted and a gauge is often required to set each tooth at the correct distance from the centre of the wheel. Each tooth is held in place by retaining bolts that are tightened to a very high degree in order to hold the teeth. The bolts and retaining brackets are required to take the full rotational force of the grinding action. The wheel is provided with a plurality of teeth, some of which are fitted to cut vertically, as the wheel moves along a horizontal and vertical axis. An example of such a grinding wheel is found in U.S. Pat. No. 6,484,766.

The teeth and receiving brackets provided on the grinding wheels known from the prior art have to be changed regularly as a result of the considerable wear that they encounter in use. Changing the teeth and receiving brackets is time consuming because of the set up accuracy required. Each tooth is generally held in place using two bolts to secure the receiving bracket and the tooth. The task of changing the tooth is invariably complicated by the earth and mud that clogs the teeth, brackets and bolt threads which then require cleaning prior to fitting of a new tooth. As a result of the earth and mud, the receiving thread in the cutting wheel and the bolt or bolts may become cross-threaded and require repair before a new tooth can be fitted. In addition to the expense incurred in a long down-time to change the teeth, the teeth and receiving brackets themselves are expensive because of the number of heavy duty components.

U.S. Pat. No. 6,550,504 shows an example of how a plurality of teeth can be attached to a rotor. Each tooth consists of a cutting tip and a body portion. The body portion includes two holes that allow the tooth to be attached to the rotor and the rotor is provided with corresponding pairs of holes for attaching the teeth by suitable fixing means, typically bolts, that pass through the tooth and the rotor and is then secured, typically using a nut that screws onto the bolt. In this way the tooth is mounted on the rotor.

There are two forces acting on the tooth that are of importance in this context. The first is the sheer force that prevents the tooth from slipping around the rotor and that arises because the tooth is not in the plane of the rotor. The second force is the bending moment which is a function of the distance between the fixing means and the cutting tip. In the example shown in U.S. Pat. No. 6,550,504, the cutting tips are positioned considerably out of the plane of the rotor and therefore the bolt will experience both the bending movement caused by the distance between the tip and the bolt and, in addition, the sheer force acting across the bolt.

U.S. Pat. No. 6,546,977 discloses a stump grinding device that reduces the force on the bolt by providing a cutting unit that is disposed in the plane of the rotor. Therefore the bending moment is considerably reduced in comparison with the example shown in U.S. Pat. No. 6,550,504. However, the sheer force across the bolt remains the means by which the force is transferred from the cutting tip to the rotor.

U.S. Pat. No. 6,375,106 discloses a machine that is designed to reduce waste by grinding. Although this is not the same technical field as the other art, some similar problems will be encountered. The teeth are replaceable and, unlike the previously discussed prior art, the attachment device is in the plane of the rotor. However, the tortuous cross section of the attachment device and locking element result in considerable stresses on certain parts of the interface between the rotor and the cutting tip.

EP 1715735 relates to a tooth for use in a grinding wheel wherein the tooth is held within a slot of the grinding wheel by means of a bolt. This has the problems that: (1) the centrifugal force and/or load of the assembly are entirely on the bolt. If the user over tightens the bolt, the bolt could stretch beyond its elastic capability and weaken, such that the bolt may break. Even though the instructions of a device of this arrangement may point the user to a recommended torque setting, in most cases the user doesn't pay attention to this and typically over tightens the bolt. (2) Contact with the soil eventually causes wear of the wheel just under the tooth slot. This eventually adversely affects the fit of the assembly, wherein the tooth does not fit as well as previously within the slot, thus putting extra stress onto the bolt. The typical life span of the wheel is 300 to 500 hours depending on the soil type. Expensive steel may be used to extend the life span but this is harder to machine in production. (3) The assembly is not always at a fixed distance from the centre of the wheel. If the slot is subject to wear and/or if the keeper and/or tooth are not manufactured to an exact size, the distance of the assembly with respect to the centre of the wheel may vary. In some cases, there may be a build up of tolerances which may make this problem worse. The relationship of the distance between one tooth and the next on the wheel would have an effect on the performance of the assembly.

Some previous systems have relied on a bolt to keep the tooth and keeper block in place within the grinding wheel. In these previous systems, the slot in the wheel was typically shaped to try to ensure that the tooth did not rattle during rotation of the wheel. In these previous systems, a lot of centrifugal force is applied to the bolt during rotation of the wheel as the combined weight of the tooth and wheel spinning at the speed required can be equivalent to a load in excess of 400 kg. This can result in a lot of wear and tear, requiring the components of the wheel to be replaced over a short period of time.

In addition, during use, wear and tear means that the teeth of the grinding wheel often have to be replaced at regular intervals.

The present invention seeks to ameliorate the problems associated with the prior art described above.

According to a first aspect, there is provided a tooth assembly for use in a grinding wheel, the tooth assembly comprising a holder for holding at least one tooth within a slot of the grinding wheel, wherein the at least one tooth comprises a tooth body, wherein the at least one tooth is removably attached to the holder by attachment means comprising a recess within the tooth body and a fixing receivable in the recess.

Preferably, the tooth body is removably attached to the holder.

Preferably, the fixing receivable in the recess may be a bolt. Preferably, the bolt may be fitted into the recess within the tooth body. In one embodiment, the recess within the tooth body may comprise an internal thread that is complimentary to a thread provided on a post of the bolt.

Preferably, the bolt is a single component. Preferably, the bolt comprises a bolt head and a post. Preferably, the bolt head and post are integrally connected to one another.

Preferably, the holder comprises a main body including a slot comprising two substantially planar surfaces. Preferably, the holder comprises a tapered channel. Preferably the tapered channel is provided on an upper surface of the holder. Preferably, the holder comprises at least one region for accommodating the at least one tooth body. Preferably, the at least one region of the holder for accommodating the at least one tooth body is circular in shape and comprises a through hole. Preferably, the bolt head is receivable within the through hole of the holder. Preferably, the bolt is rotatable within the through hole of the holder. Typically, the through hole of the holder is counter bored to partially conceal the bolt head. Typically, the inner surface of the through hole of the holder has a smooth surface and is not threaded. Typically, the inner surface of the through hole is substantially circular in shape. In one embodiment, the inner surface of the through hole comprises at least one substantially flat portion. Typically, in use, the bolt may be freely pushed through the through hole of the holder and may be screwed into the tooth body.

Typically, the tooth body is cylindrical or substantially cylindrical in shape. In one embodiment, a portion of the outer surface of the tooth body comprises at least one substantially flat surface. Typically, an upper portion of the outer surface of the tooth body comprises at least one substantially flat surface. In one embodiment, a portion of the outer surface of the tooth body comprises three flat surfaces. Typically, in use, the tooth body is located within the holder by locating the at least one substantially flat surface of the tooth body against the at least one substantially flat surface of the through hole. Advantageously, locating the at least one substantially flat surface of the tooth body against a corresponding substantially flat surface of the through hole holds the tooth body securely in place within the holder. In other embodiments, the tooth body may be held within the through hole by another mechanism. For example, in other embodiments, the tooth body may be held within the through hole by friction or another mechanism.

In one embodiment, an aperture is provided within the head of the bolt. Preferably, the aperture is shaped to accommodate an allen key or other means for assisting with the reversible attachment of the bolt to the tooth body. In one embodiment, the aperture has a hexagonal shape.

Preferably, the tooth body is provided as a nut and the reversible attachment means is a bolt. Typically, the tooth resembles a nut comprising a carbide face. Preferably, the tooth resembles a nut comprising a carbide end face. In another embodiment, the tooth body may be structured in the form of a bolt and the reversible attachment means may be provided as a nut.

Advantageously, the use of a reversible attachment means to reversibly secure the tooth body to the holder means that the bolt may be reused. Advantageously, the individual components of the tooth may be replaced when worn or damaged without the need to replace the whole assembly, thus decreasing cost and reducing waste.

Advantageously, in the assembled configuration, the combination of the holder and tooth body which may be secured together by a reversible attachment means provides a stable arrangement. Advantageously, the tooth comprises components which may be fitted together to provide a stable arrangement in use, but then separated from one another when not in use, thus assisting in shipping and transport of the tooth since in the separate configuration the components will be smaller and thus easier to ship and store.

Preferably, the tooth holder may comprise an alloy steel. Advantageously, the provision of a tooth holder comprising an alloy steel increases strength and wear resistance of the holder.

Preferably, the holder may be made using an injection mould method. In an alternative embodiment, the holder may be made by forging or by machining from a block.

Preferably, the bolt may comprises metallic material. Preferably, the bolt may be a standard high tensile bolt of 12.9 grade. Advantageously, the use of a standard bolt means that it is easy to obtain and replace the bolt within the system at low cost.

Preferably, the tooth may comprise an alloy steel. Preferably, the tooth body may comprise an alloy steel. Preferably, the tooth comprises at least one cutting face connected to and extending away from the tooth body. Preferably, the at least one cutting face comprises at least one tip.

Preferably, the at least one tip is soldered to the tooth body. In one embodiment, the at least one tip is integral with the tooth body. Preferably, the tip may comprise a carbide material. Preferably, the tip may comprise a tungsten carbide material. Advantageously, the tip is very hard and durable and as a result, the edges of the at least cutting face remain sharper for a long period of time. Preferably, the tooth comprises the tooth body and the at least one tip.

Typically, the at least one cutting face is substantially circular in shape and comprises a substantially circular outer surface. Typically, the at least one cutting face is circular in shape and comprises a circular outer surface. Typically, in use, the outer and front surface of the cutting face is exposed during cutting and thus become worn more quickly than the other sections of the cutting face. Typically, in use, when a portion of the exposed section of the cutting face becomes worn and loses its sharpness, the user may rotate the tooth body within the holder such that one of the other sections of the cutting face is at the outer and front position.

Typically, in use, when an outer section of the cutting face becomes worn the user may rotate the tooth body to reveal an unworn section. Typically, in use, when an outer section of the cutting face becomes worn the user may rotate the tooth body through 90 degrees, 120 degrees, 180 degrees or another angle, thus replacing the worn edge with a sharp edge. Typically, in use, once all sections of the outer surface of the cutting face have become worn, the tooth can be removed from the holder and replaced with a new tooth. Advantageously, the removal of the tooth from the holder and replacement with a new tooth means that a minimum amount of material will need to be replaced since the bolt and holder will last for longer than the tooth.

Preferably, the tooth body comprises a substantially cylindrical wall and opposing first and second end faces. Preferably, the opposing first and second faces are substantially circular. Preferably, the second end face comprises the cutting tip. Preferably, the tooth body comprises a blind bore. Preferably, the blind bore is threaded. Preferably, the bolt screws into the blind bore to attach the tooth to the holder. Preferably, the bolt screws into the blind bore to attach the tooth body to the holder. Preferably, the bolt screws into the face of the tooth body opposite to the cutting tip. In one embodiment, the blind bore is provided within the tooth. In one embodiment, the blind bore is provided within the tooth body. In another embodiment, the blind bore is provided within the tip. Preferably, the tooth body and tip provide the blind bore, wherein the tip acts as a closure means to the recess provided within the tooth body to provide the blind bore. Advantageously, the provision of a blind bore protects the end of the bolt from wear during the process of grinding. Advantageously, in the embodiment wherein the tip comprises a carbide material, the carbide material of the tip advantageously protects the end of the bolt. Typically, without this feature there would be excessive wear to the end of the bolt, for example, during grinding. Another advantage is that the provision of a blind bore means that wet fibrous material that is generated during the process of grinding doesn't get into the screw thread and interfere or prevent the changing of the teeth within the tooth assembly.

In one embodiment, the tooth assembly may further comprise means for locking the tooth in the slot of the wheel.

In one embodiment, the tooth may comprise a spigot. In one embodiment, the grinding wheel may comprise a recess. In one embodiment, the spigot of the tooth fits within the recess of the grinding wheel, wherein the spigot and recess interact to lock the tooth within the slot of the wheel. In one embodiment, the recess may be provided within a slot of the grinding wheel.

In another embodiment, the tooth may comprise a recess which may cooperate with a spigot provided within a slot of the grinding wheel, wherein the spigot and the recess interact to lock the tooth within a slot of the wheel. Advantageously, the provision of a spigot provided within a slot of the grinding wheel and a recess provided within a tooth locates the tooth within the grinding wheel and holds the tooth in place. Advantageously, the tooth is held positively within the slot by the engagement of the spigot with the recess, holding the tooth securely within the slot.

In one embodiment, the tooth assembly further comprises means for cooperating with a keeper block. Preferably, the keeper block is dimensioned to fit with the tooth assembly within a slot of the grinding wheel. In one embodiment, the keeper block may be attached to the tooth assembly by means of a keeper block bolt. It is preferred that the keeper block bolt passes through the keeper block and attaches to a rear portion of the tooth assembly. In one embodiment, the keeper block is dimensioned to fit within the slot provided within the holder of the tooth assembly. Typically, the keeper block is dimensioned to fit within the tapered channel provided within the holder of the tooth assembly.

In previous systems, a threaded insert or a tapped hole was typically provided in the grinding wheel. Advantageously, the arrangement of the present invention wherein the tooth comprises a threaded portion means that one less component is required in the system, thus facilitating manufacture and minimising the amount of work required to make the wheel. In addition, the arrangement of the present invention has the advantage that the thread is changed when the tooth is changed as the thread is part of the tooth (i.e. the thread and tooth are part of the same component), thus improving the safety of using a tooth and a grinding wheel in accordance with the present invention.

Preferably, the keeper block is counter bored to allow passage of the keeper block bolt through the keeper block. Preferably, the keeper block bolt is attached to the tooth assembly by means of a threaded engagement. Preferably, the keeper block is shaped such that it corresponds with the shape of the tooth assembly, such that the combination of the keeper block and tooth fit within a slot of the grinding wheel. It is preferred that the keeper block is dimensioned such that it fits within the slot provided within the holder of the tooth assembly. Preferably, the keeper block is dimensioned such that it fits within the tapered channel provided within the holder of the tooth assembly. Typically, the underside of the keeper block is provided with a tapered surface that interfaces with the surface of the tooth assembly. Typically, the taper on the lower surface of the keeper block is approximately 11°. In this embodiment, the keeper block and tooth assembly advantageously fit together and are sized to fit within the slot of the grinding wheel. Advantageously, in this embodiment, the keeper block and tooth assembly move together relative to the slot provided within the grinding wheel. Advantageously, in this embodiment, the keeper block and tooth assembly are held securely within the slot. In one embodiment, the tooth assembly and keeper block may be formed as one component. In another embodiment, the tooth and keeper block may be separate components.

In previous systems, the tooth was typically not held securely within the slot of the grinding wheel and could move backwards and forwards within the slot. The present system advantageously allows for the tooth to be held securely within the slot of the grinding wheel.

Advantageously, the tooth assembly may be locked in place by pulling a wedged keeper block in and forcing the spigot on the lower part of the tooth into the recess in the wheel, or alternatively, by forcing the spigot provided on the wheel into the recess provided on the tooth. Advantageously, the provision of the spigot on the grinding wheel locates the tooth assembly within the wheel and holds the tooth in place. Advantageously, the provision of the spigot within a slot of the grinding wheel which engages with a corresponding recess provided within the tooth holds the tooth assembly securely within the slot of the grinding wheel. Thus, in this embodiment, the tooth assembly advantageously locates positively within the slot in the wheel.

Advantageously, the engagement of the spigot with the recess provides an interlocking, positive mechanical engagement. Advantageously, the engagement of the recess with the spigot provides an interlocking, positive mechanical engagement. This is in contrast to previous systems which involved a fit under tension from a screw. Advantageously, the present invention uses forces in the radial, tangential and axial directions relative to the axis of rotation of the grinding wheel, wherein the force in the radial direction is provided by the reaction surfaces between the spigot and the recess, and the force in the tangential direction is provided by the tapered keeper block and the surfaces on either side thereof, and the force in the axial direction is provided by the walls of the slot within the tooth.

In addition, the interlocking of the spigot and the recess advantageously means that the wheel will take the major centrifugal forces created by the tooth during rotation of the wheel, thus minimising wear of the wheel and tooth. Advantageously, in this embodiment, the keeper block bolt now only has to keep the keeper block in place which results in a much lower force being applied to the bolt during rotation. In addition, the interaction of the spigot and recess has the further advantage that the tooth is located in one position in the wheel and can't slide further as the slot wears. Advantageously, in this embodiment, the tooth is held in position within the wheel. Advantageously, the provision of a spigot on the wheel which engages with a recess on the tooth holds the tooth in place during rotation and enables the wheel to take the centrifugal forces created by the tooth during rotation of the wheel. Advantageously, the provision of the spigot on the wheel locates the tooth and holds it in position within the wheel.

In one embodiment, the keeper block and tooth assembly may be combined and provided as one component. In this embodiment, the load on the keeper block and tooth assembly would typically be similar. In another embodiment, the keeper block and tooth assembly may be provided as separate components. In one embodiment, the spigot and recess may be provided between the keeper block and the tooth. In one embodiment, the interlocking between the spigot and recess may occur between the keeper block and the tooth. In another embodiment, the spigot or recess may be provided on the keeper block and may interlock with a corresponding recess or spigot provided on the tooth or within the slot of the wheel. In one embodiment, the spigot may be provided on the keeper block which may engage with a recess provided on the tooth.

Preferably, in use, the two substantially planar surfaces of the holder may engage with the keeper block.

In one embodiment, the cutting face may comprise one tip. In another embodiment, the cutting face may comprise two or more tips. In an embodiment wherein the tooth comprises two or more tips, the tips may be perpendicular to each other. In another embodiment, the multi-tipped tooth may have protruding transverse tips to facilitate lateral grinding, in addition to radial tips. Such a multi-tipped tooth allows for cutting in radial and lateral dimensions simultaneously.

Some additional advantages of embodiments of the present invention are: (1) the tooth assembly may be quickly removed and replaced within the grinding wheel; (2) the tooth assembly has good performance; (3) typically, the only part of the assembly, excluding the wheel, that wears is the tooth; (4) the keeper block, threaded insert and keeper block bolt are protected by the tooth assembly; (5) typically, only one relatively small keeper block bolt is required because all of the forces are taken up through the wheel. Previous systems typically had pockets on both side faces of the wheel which would hold the teeth; (5) typically, the keeper block bolt is not taking the centrifugal force of the whole assembly (typically approximately 0.74 kg), but instead has the centrifugal force of itself and the small keeper block; (6) typically, there are fewer components, or, in the case where the wheel has been drilled and tapped instead of using a threaded insert, extra machining is not required; (7) preferably, a section is included within the tooth assembly that protects the wheel from wear, such that standard mild steel can be used which is cheaper and easier to machine than the material used in conventional equipment, such that the wheel that may be used with the present invention may last up to ten times longer than previous wheels; and (8) the individual components of the tooth assembly may be replaced separately, thus reducing cost. Advantageously, the assembly of the present invention is preferably provided at a fixed position relative to the centre of the wheel, such that the variability in performance found with previous wheels is minimised resulting in perfect performance every time.

Advantageously, the wheel absorbs a substantial proportion of the forces in the plane of the grinding wheel resulting from the grinding action. Advantageously, the interaction between the spigot and recess provides for a secure interaction between the grinding wheel and the tooth. Advantageously, the means for locking the tooth within a slot of the wheel provides for a secure attachment of the tooth within the wheel. Advantageously, the provision of cooperating interlocking structures in the form of a recess and spigot on the tooth and the wheel provide for a secure attachment of the tooth and the wheel.

When the term “slot” is used in this specification, it is intended to refer to any physical configuration that provides two planar surfaces that enable the interlocking of a second piece. In particular, a simple slot may be provided in the circumference of the grinding wheel by cutting a substantially U-shaped gap in the periphery of the wheel thus providing two substantially planar surfaces into which a tooth may be slotted in use. Preferably, the slots within the grinding wheel may be arranged in diametrically opposed pairs wherein the slots in an opposing pair of slots are the same distance from the axis. Preferably, the slots within the grinding wheel are arranged in two diametrically opposed series, each successive slot within each series having an increased distance from the axis.

Preferably, the number of slots within the grinding wheel is 4, 6, 8, 10 or 12. Preferably, some or all of the grinding wheel slots may be angled either towards or away from the axis of rotation of the grinding wheel. Typically, if the slots within the grinding wheel are angled towards the axis of rotation, the teeth will protrude perpendicular to the rim of the grinding wheel and will therefore, dependent on the configuration of cutting tips of the teeth, the grinding wheel could be rotated in either direction.

According to a second aspect, there is provided a grinding wheel comprising a tooth assembly in accordance with the first aspect.

Preferably, the grinding wheel comprises at least one slot, wherein the tooth comprises means for cooperating with a corresponding structure within the at least one slot of the grinding wheel and means for locking the tooth in the at least one slot of the wheel.

In one embodiment, the grinding wheel comprises a recess which may engage with a spigot provided on the tooth.

In another embodiment, the grinding wheel comprises a spigot which may engage with a recess provided on the tooth.

Preferably, the recess or spigot is provided within the at least one slot of the grinding wheel.

Preferably, the recess cooperates with the spigot to lock the tooth within the at least one slot of the grinding wheel.

Advantageously, the engagement of the spigot with the recess provides an interlocking, positive mechanical engagement. Advantageously, the engagement of the recess with the spigot provides an interlocking, positive mechanical engagement. This is in contrast to previous systems which involved a fit under tension from a screw. Advantageously, the present invention uses forces in the radial, tangential and axial directions relative to the axis of rotation of the grinding wheel, wherein the force in the radial direction is provided by the reaction surfaces between the spigot and the recess, and the force in the tangential direction is provided by the tapered keeper block and the surfaces on either side thereof, and the force in the axial direction is provided by the walls of the slot within the tooth.

In addition, the interlocking of the spigot and the recess advantageously means that the wheel will take the centrifugal forces created by the tooth during rotation of the wheel, thus minimising wear of the wheel and tooth. Advantageously, the keeper block bolt now only has to keep the keeper block in place which results in a much lower force being applied to the bolt during rotation. In addition, the interaction of the spigot and recess has the further advantage that the tooth is located in one position in the wheel and can't slide further as the slot wears.

Advantageously, the provision of a spigot on the wheel which engages with a recess on the tooth holds the tooth in place during rotation and enables the wheel to take the centrifugal forces created by the tooth during rotation of the wheel.

According to a third aspect, there is provided a cutting apparatus comprising a grinding wheel in accordance with the second aspect and a tooth assembly in accordance with the first aspect.

According to a fourth aspect, there is provided a method of engaging a tooth assembly according to the first aspect with a grinding wheel according to the second aspect.

The invention will further be described by way of example, with reference to the accompanying drawings, in which:

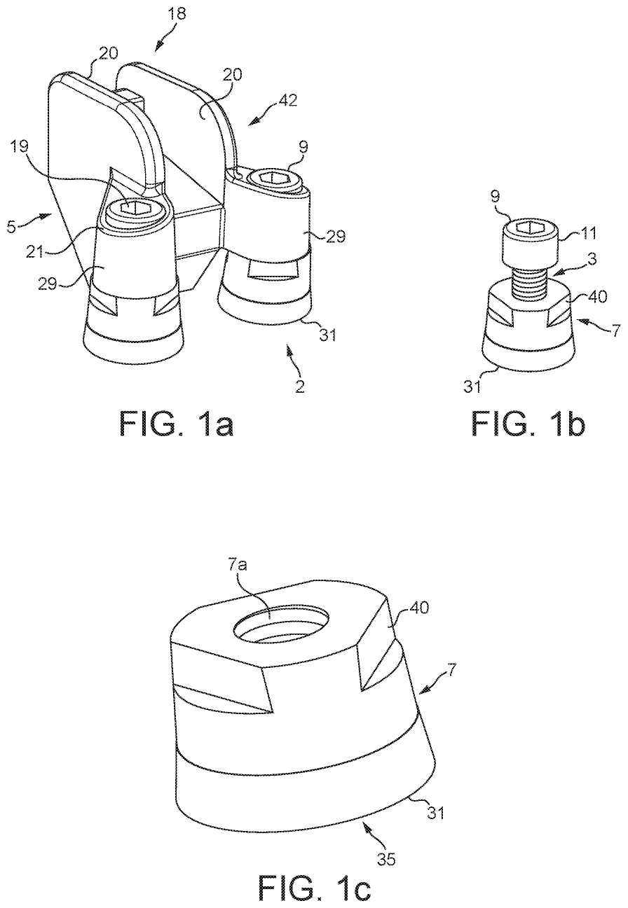

FIG. 1(a) shows a perspective view of the tooth assembly according to an embodiment of the invention;

FIG. 1(b) shows a perspective view of a tooth and bolt according to an embodiment of the invention;

FIG. 1(c) show a perspective view of a tooth according to an embodiment of the invention;

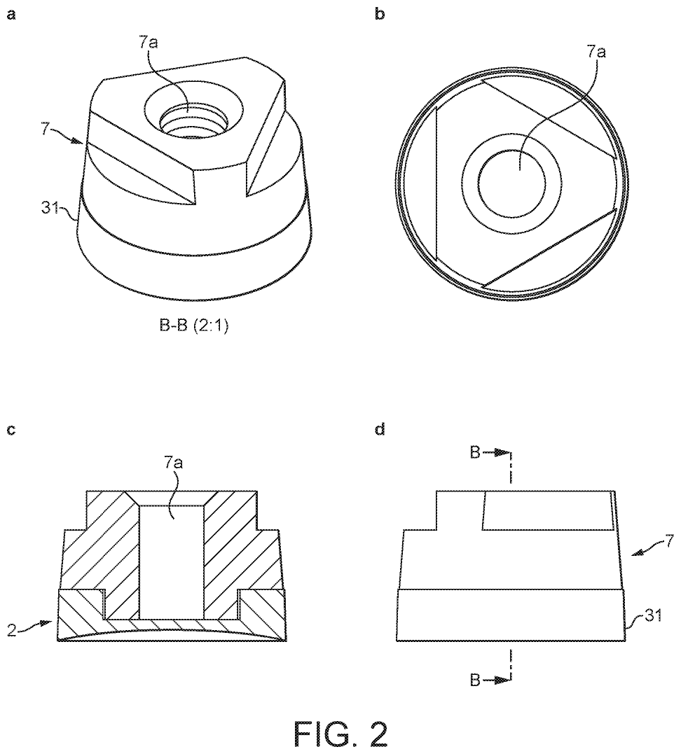

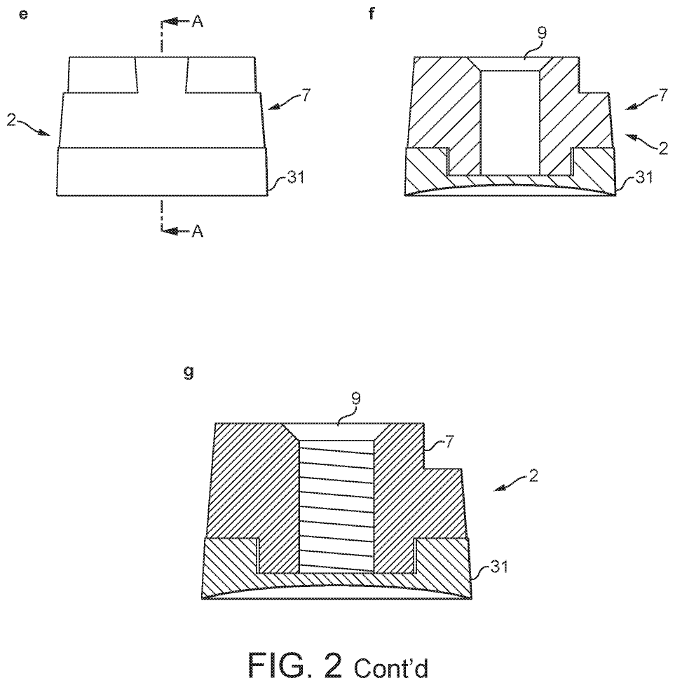

FIG. 2(a) shows a perspective view of a tooth according to an embodiment of the invention;

FIG. 2(b) shows a top plan view of a tooth according to an embodiment of the invention;

FIG. 2(c) shows a sectional view on line B-B in FIG. 2(d);

FIG. 2(d) shows a side view of a tooth according to an embodiment of the invention;

FIG. 2(e) shows a side view of a tooth according to an embodiment of the invention;

FIG. 2(f) shows a sectional view along line A-A in FIG. 2(e);

FIG. 2(g) shows a sectional view of a tooth and bolt according to an embodiment of the invention wherein the tooth comprises a blind bore;

FIG. 3(a) is an exploded perspective view of the apparatus according to an embodiment of the invention;

FIG. 3(b) is an assembled side view of the apparatus of FIG. 3(a);

FIG. 3(c) is an exploded perspective view of the apparatus according to an embodiment of the invention;

FIG. 3(d) is an assembled perspective view of the apparatus of FIG. 3(c);

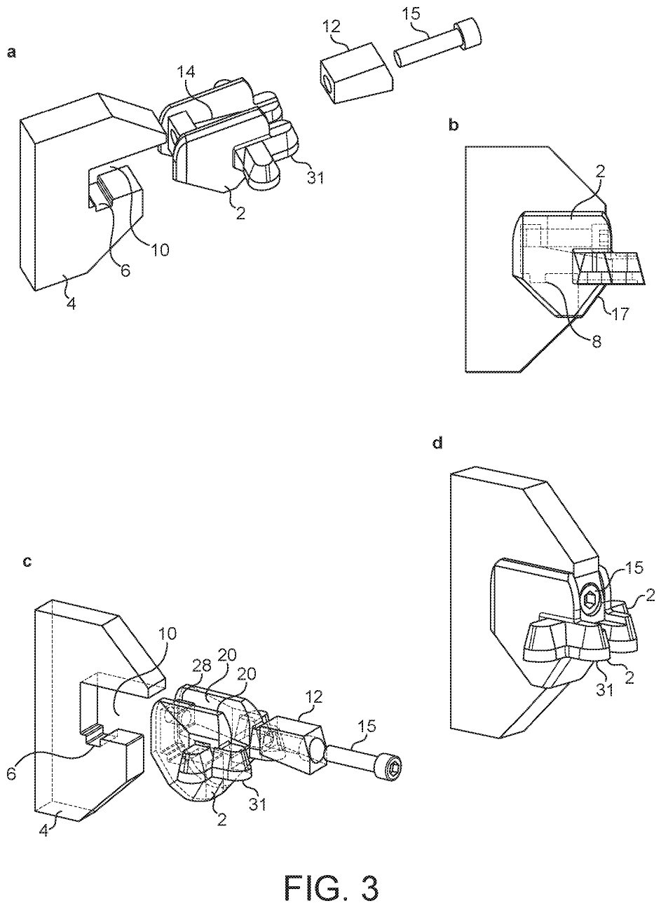

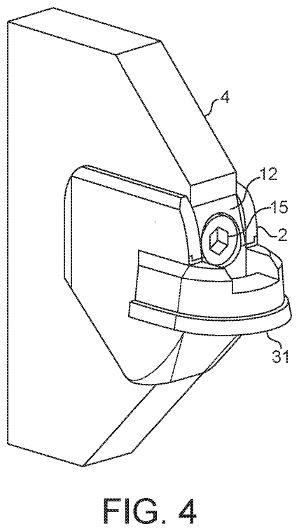

FIG. 4 is an assembled view of apparatus according to an embodiment of the invention;

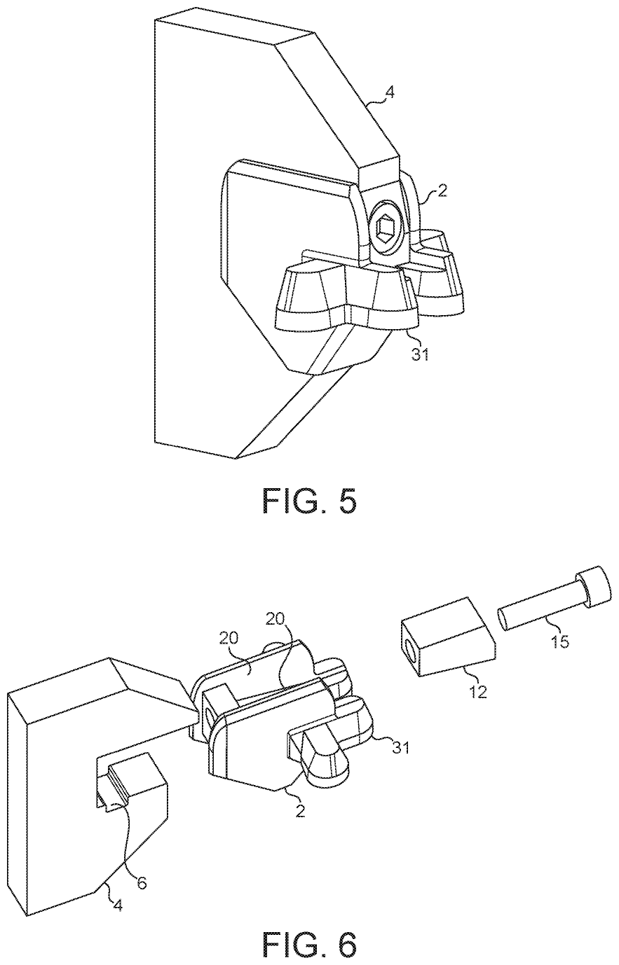

FIG. 5 is a perspective view of apparatus according to an embodiment of the invention;

FIG. 6 is an exploded perspective view of apparatus according to an embodiment of the invention;

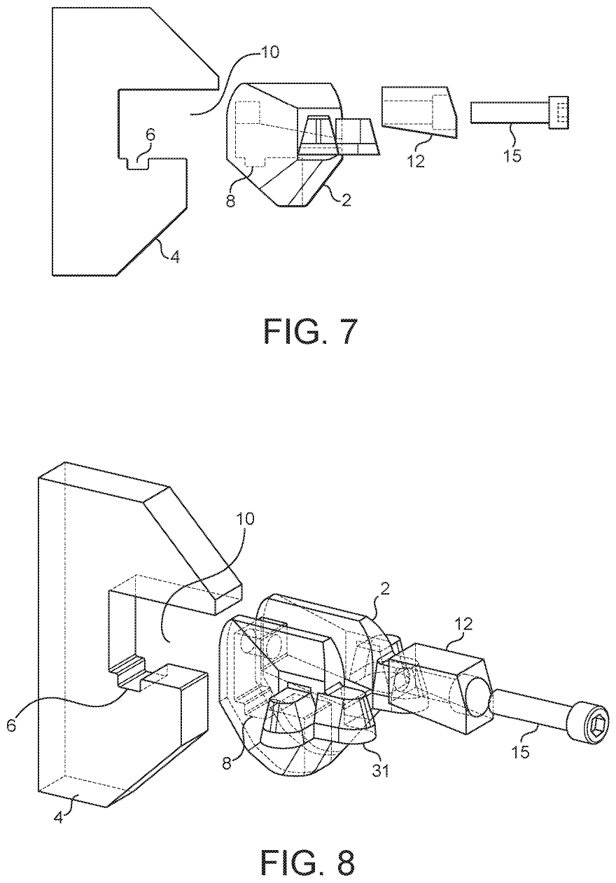

FIG. 7 is an exploded plan side view of apparatus according to an embodiment of the invention;

FIG. 8 is an exploded perspective view of apparatus according to an embodiment of the invention; and

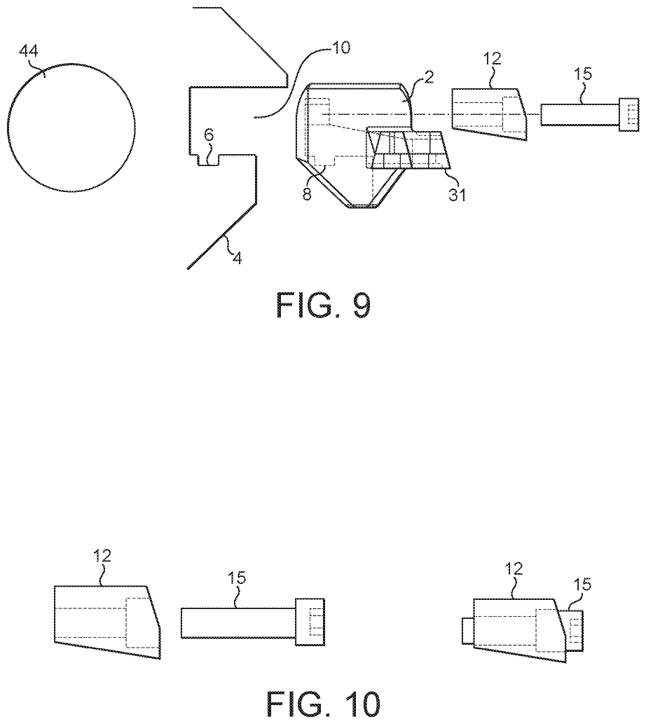

FIG. 9 is an exploded plan side view of apparatus according to an embodiment of the invention;

FIG. 10 is a side plan view of a part of apparatus according to an embodiment of the invention;

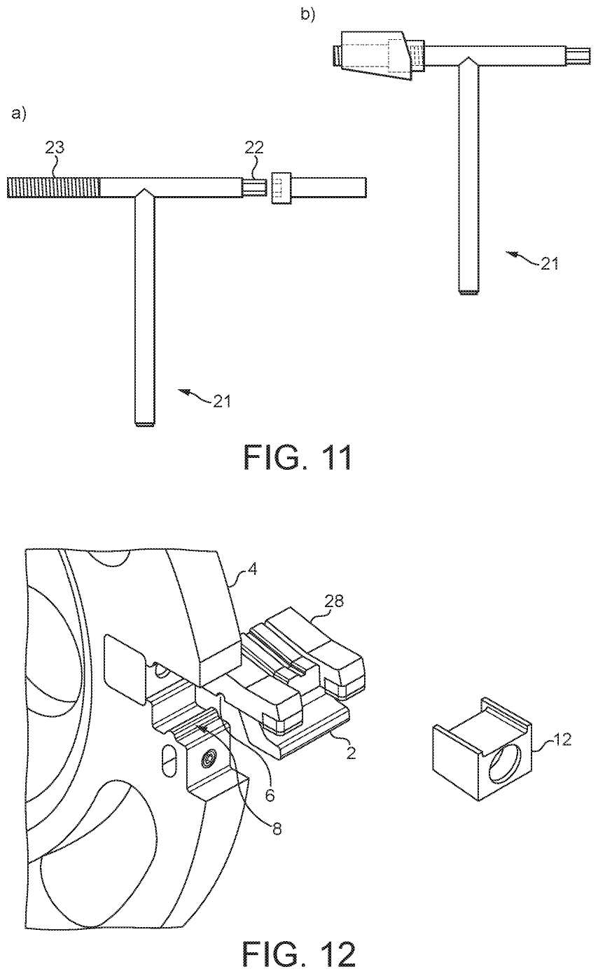

FIG. 11(a) is a side view of a tool that may be used with part of the apparatus of the invention;

FIG. 11(b) is a side view of a tool in combination with part of the apparatus of the invention; and

FIG. 12 is a perspective view of apparatus according to another embodiment of the invention.

With reference to FIGS. 1(a), (b) and (c), there is provided a tooth assembly 42 for use in a grinding wheel 4, the tooth assembly comprising a holder 5 for holding at least one tooth 2 within a slot of the grinding wheel, wherein the at least one tooth comprises a tooth body 7, wherein the tooth body is removably attached to the holder by attachment means comprising a recess within the tooth body and a corresponding bolt 9.

FIG. 1(a) shows a tooth assembly 42 according to an embodiment of the invention, FIG. 1(b) shows a tooth and bolt according to an embodiment of the invention, and FIG. 1(c) shows a tooth according to an embodiment of the invention. In the embodiment shown in FIG. 1(a), the tooth assembly comprises a holder comprising two through holes.

The bolt 9 may be fitted into the recess within the tooth body. The bolt preferably comprises a bolt head 11 and a post 3. The recess comprises an internal thread that is complimentary to a thread provided on a post 3 of the bolt.

The bolt head 11 and post 3 are integrally connected to one another such that the bolt is provided as a single component.

The holder 5 comprises a main body 18 including a slot comprising two substantially planar surfaces 20. The holder comprises a tapered channel on the upper surface thereof. The holder 5 further comprises two regions 29, each region accommodating a tooth 2. The regions for accommodating the tooth 2 are both circular in shape and each comprises a through hole 21. The bolt head 11 is receivable within the through hole 21 and is rotatable within the through hole. The through hole is counter bored to semi conceal the bolt head. The inner surface of the through hole of the holder has a smooth surface and is not threaded. The inner surface of the through hole is substantially circular in shape and further comprises a substantially flat portion. In use, the bolt may be freely pushed through the through hole of the holder and then screwed into the tooth body.

The tooth body 7 is substantially cylindrical in shape and a portion 40 of the outer surface of the tooth body comprises at least one substantially flat surface. In use, the tooth body 7 is located a the substantially flat surface of the holder. Advantageously, locating the at least one substantially flat surface of the tooth body against a corresponding substantially flat surface of the through hole holds the tooth body securely in place within the holder. It will be understood that in other embodiments, the tooth body may be held in the holder by another mechanism, for example, by a frictional fit.

An aperture 19 is provided within the bolt head. The aperture 19 is shaped to accommodate an allen key or other means for assisting with the reversible attachment of the bolt to the tooth body.

The tooth holder 5 comprises an alloy steel and is typically made using an injection mould method. In an alternative embodiment, the holder is made by forging or by machining from a block.

The bolt 9 is a standard high tensile bolt of 12.9 grade.

The tooth body 7 comprises an alloy steel and the tooth further comprises a cutting face 31 connected to and extending away from the tooth body 7. The cutting face comprises a tip which is soldered to the tooth body. The tip comprises a tungsten carbide material.

The cutting face 31 is substantially circular in shape and comprises a substantially circular outer surface 35. In use, the outer and front section of the cutting face is exposed during cutting and thus become worn more quickly than the other sections of the cutting face. In use, when a portion of the exposed section of the cutting face becomes worn and loses its sharpness, the user may rotate the tooth body within the holder such that one of the other surfaces of the cutting face is at the outer and front position. In use, when an outer section of the cutting face becomes worn the user may rotate the tooth body to reveal an unworn section. In use, once all sections of the outer surface of the cutting face have become worn, the tooth can be removed from the holder and replaced with a new tooth. Advantageously, the removal of the tooth from the holder and replacement with a new tooth means that a minimum amount of material will need to be replaced since the bolt and holder will last for longer than the tooth.

The tooth body 7 comprises a substantially cylindrical wall and opposing first and second end faces. The tooth comprises a screw thread and a blind bore 7a (also known as a blind hole), wherein the bolt screws into the blind bore to attach the tooth to the holder. The blind bore 7a is provided within the recess. In one embodiment, the bolt screws into the face of the tooth opposite to the cutting tip. The opposing first and second faces are substantially circular. In one embodiment, the tooth body comprises the blind bore. In one embodiment, the blind bore is provided by the tip. In another embodiment, the tooth body and tip provide the blind bore by virtue the recess in the tooth body which is closed by the tip provided at an end of the tooth body. This arrangement can be seen, for example, in FIG. 2(g) wherein the bolt passes through the recess in the tooth body and the cutting tip provides a closure means to the recess, thus providing a blind bore. Advantageously, the provision of a blind bore means that wet fibrous material that is generated during the process of grinding doesn't get into the screw thread and interfere or prevent the changing of the teeth within the tooth assembly. In addition, the blind bore advantageously protects the end of the bolt and without this there would be excessive wear to the bolt during grinding. Advantageously, the carbide material of the tip protects the end of the bolt as without this there would be excessive wear to the bolt, for example, during grinding.

FIGS. 2(a) to 2(g) illustrate the blind bore 7a, wherein the recess within the tooth body is closed by the tip to provide a blind bore.

The tooth assembly further comprises means for cooperating with a keeper block 12, wherein the keeper block is dimensioned to fit within the slot provided within the holder, for example, as defined by surfaces 20 within the holder.

In the embodiment shown in FIG. 3, the tooth comprises a spigot 8 which fits within the recess 6 of the grinding wheel 4. The recess 6 is provided within a slot 10 of the grinding wheel. The recess 6 is provided as a depression within a lower surface of the slot 10 of the grinding wheel. The grinding wheel has central region 44 (see, for example, FIG. 9).

With reference to FIG. 3, the tooth assembly further comprises means for cooperating with a keeper block 12, wherein the keeper block is dimensioned to fit with the tooth assembly within a slot 10 of the grinding wheel 4. As shown, for example, in FIG. 4, the keeper block 12 is attached to the tooth 2 by means of a keeper block bolt 15, wherein the keeper block bolt 15 passes through the keeper block 12 and attaches to a rear portion of the tooth 2. In this embodiment, the keeper block bolt 15 is attached to the tooth 2 by means of a threaded engagement, wherein the keeper block bolt 15 passes through the keeper block 12 and screws into the back portion of the tooth 2. Advantageously, the tooth of the present invention does not require a keeper block bolt 15 to be attached to the grinding wheel 4, thus preventing wear of the wheel over time. Advantageously, the locking mechanism allows for replacement of the tooth 2 and keeper block 12 components instead of the wheel 4 during wear. In this embodiment, the keeper block is counter bored and tapped to M12. The bolt is preferably an M10 socket cap which typically passes directly through the tapped hole and screws into a threaded M10 hole in the tooth. Advantageously, the head of the bolt sits in and is protected by the counter-bored section of the keeper block (see, for example, FIG. 10).

With reference to FIG. 3, the keeper block 12 is shaped such that it corresponds with the shape of the tooth 2, such that the combination of the keeper block 12 and tooth 2 fit within a slot of the grinding wheel 4. The underside of the keeper block is provided with a tapered surface that interfaces with the surface of the tooth. Typically, the taper on the lower surface of the keeper block is approximately 11°. The keeper block 12 and tooth 2 advantageously fit together and are sized to fit within the slot 10 of the grinding wheel 4. Advantageously, the keeper block 12 and tooth 2 move together relative to the slot 10 provided within the grinding wheel 4. Advantageously, the attachment of the keeper block of the present invention to the tooth by means of a bolt allows for a shorter bolt to be used than in previous assemblies.

In the embodiment shown in FIG. 3, the tooth 2 comprises a main body 28 including a slot comprising two substantially planar 20 surfaces for, in use, engaging with the keeper block 12. The tooth 2 comprises one or more cutting face 31 connected to and extending away from the main body, wherein the cutting face includes one or more tips 31. In the embodiment wherein the tooth 2 comprises two or more tips 31, the tips may be perpendicular to each other. In another embodiment, the multi-tipped tooth may have protruding transverse tips to facilitate lateral grinding, in addition to radial tips. Such a multi-tipped tooth allows for cutting in radial and lateral dimensions simultaneously. The tips 31 may comprise a carbide material. Advantageously, the tooth 2 may comprise a region 17 comprising replaceable components to prevent wear of the wheel.

In the embodiment shown in FIG. 3(c), the rear of the tooth 2 is provided with a threaded M10 to allow for a corresponding M10 bolt to screw into the tooth. The keeper block 12 is preferably threaded to M12. This allows an M12 bolt 15 to act as a jacking screw which will bottom out and force the wedge shaped keeper block out when disassembling. The keeper block 12 is counter bored to allow the keeper block bolt 15 to pass therethrough, as shown in FIG. 3(d).

In the embodiment shown in FIG. 3(d), the keeper block 12 is counted bored to accept an M10 bolt head. A longer M12 bolt is used as a jacking screw which will force the wedge shaped keeper block out when disassembling. In the embodiment shown in FIG. 3(d), the tooth comprises multiple tips 31, wherein the tips provide the cutting face of the tooth. In this embodiment, each of the tips comprises carbide material. Advantageously, the hard carbide tips reduce wear of the assembly and allow the teeth to last longer, especially when the teeth come into contact with soil.

Advantageously, the arrangement wherein the tooth comprises a threaded portion means that one less component is required in the system, thus facilitating manufacture of the wheel and tooth. In addition, the provision of a tooth comprising a threaded portion has the advantage that the thread is changed when the tooth is changed, thus improving the safety associated with using a wheel and a tooth in accordance with the present invention.

Advantageously, only one tool 21 is required to drill the bolt into the keeper block and tooth, as shown in FIG. 11. One end 22 of the tool typically has an 8 mm hex head which fits into the M10 bolt head for tightening. The other end 23 of the tool is typically tapped to M12. This is used for extracting the keeper block. Once the bolt has been removed, the threaded end screws into the keeper block and bottoms out on the back of the tooth. Continuing to wind the thread in will push the keeper block out. Then the tooth can be removed freely. This is in contrast with previous systems where two tools are typically required, an allen key and a hammer. In previous systems, the hammer is used to knock the tooth out of the slot after the bolt has been removed.

In the embodiment shown in FIG. 4, the tooth 2 comprises a single tip 31. The locking mechanism of this embodiment is the same as that described above in relation to FIG. 3.

During rotation, the wheel 4 absorbs a substantial proportion of the forces in the plane of the grinding wheel resulting from the grinding action. The locking mechanism of the invention assists in retaining the tooth 2 in place within the grinding wheel slot 10 as the grinding wheel 4 rotates.

The slots within the grinding wheel may be arranged in diametrically opposed pairs wherein the slots in an opposing pair of slots are the same distance from the axis. The slots within the grinding wheel are typically arranged in two diametrically opposed series, each successive slot in each series having an increased distance from the axis. The number of slots is preferably 4, 6, 8, 10 or 12. Some or all of the slots within the grinding wheel may be angled either towards or away from the axis of rotation of the grinding wheel. If the grinding wheel slots are angled towards the axis of rotation, the teeth will protrude perpendicular to the rim of the grinding wheel and will therefore, dependent on the configuration of cutting tips of the teeth, the grinding wheel could be rotated in either direction.

Thus, with reference to FIGS. 3 and 4, the tooth may comprise one or more cutting tips, a spigot in the underside of the channel which locates in a recess provided within a slot of the wheel, a tapered channel on the upper side of the tooth, and/or a threaded section at the back of the tooth. The keeper block is tapered on the underside and/or comprises a counter-bored hole from the front to the back.

In use, the tooth 2 may be fitted by locating the spigot 8 in the recess 10 of the wheel 4. The keeper block 12 comprises a tapered surface which slides into a tapered channel 14 provided on an upper surface of the tooth 2. The keeper block bolt 15 passes through the keeper block 12 and screws into the back of the tooth 2. As the keeper block 12 is pulled in, it typically pushes the spigot 8 on the underside of the tooth 2 firmly into the recess 10 in the wheel 4 and locks the assembly tightly in place.

FIG. 12 shows a tooth 2 for use in a grinding wheel 4, the tooth 2 comprising means 6 for cooperating with a corresponding structure 8 within a slot 10 of the grinding wheel and a keeper block bolt 15 for locking the tooth in the slot of the wheel. In this embodiment, the tooth comprises a recess 6 which accommodates a spigot 8 provided within the grinding wheel. Advantageously, the provision of a spigot provided within the grinding wheel and a recess provided within a tooth locates the tooth within the grinding wheel and holds the tooth in place. Advantageously, the tooth is held positively within the slot by the engagement of the spigot with the recess, holding the tooth securely within the slot. This interlocking between the cooperating structures on the tooth and the wheel means that the wheel will take the major centrifugal forces created by the tooth during rotation of the wheel. The keeper block bolt now only has to keep the keeper block in place. This results in much less force being applied to the bolt. In addition, this arrangement has the advantage that the tooth is located in one position in the wheel and can't slide further into the slot as the slot wears. In particular, the provision of a spigot on the wheel which interacts with a recess on the tooth enhances and provides for a secure locking of the tooth within the wheel, thus allowing the wheel to take the major centrifugal forces created by the tooth during rotation.

In this embodiment, the tooth further comprises means for cooperating with a keeper block 12, wherein the keeper block is dimensioned to fit with the tooth 2 within a slot of the grinding wheel 4. The keeper block 12 is attached to the tooth 2 by means of a keeper block bolt 15, wherein the bolt 15 passes through the keeper block 12 and attaches to a rear portion of the tooth 2. The keeper block bolt 15 may be attached to the tooth 2 by means of a threaded engagement, wherein the keeper block bolt 15 passes through the keeper block 12 and screws into the back portion of the tooth 2. Advantageously, the tooth of the present invention does not require a keeper block bolt 15 to be attached to the grinding wheel 4, thus preventing wear of the wheel over time. Advantageously, the locking mechanism allows for replacement of the tooth 2 and keeper 12 components instead of the wheel 4 during wear. The keeper block may be counter bored and tapped to M12. The bolt is preferably an M10 socket cap which typically passes directly through the tapped hole and screws into a threaded M10 hole in the tooth.

Advantageously, the head of the bolt sits in and is protected by the counter-bored section of the keeper block.

With reference to FIG. 12, the keeper block 12 (also known as a wedge) is shaped such that it corresponds with the shape of the tooth 2, such that the combination of the keeper block 12 and tooth 2 fit within a slot of the grinding wheel 4. The underside of the keeper block is provided with a tapered surface that interfaces with the surface of the tooth. Typically, the taper on the lower surface of the keeper block is approximately 11°. The keeper block 12 and tooth 2 advantageously fit together and are sized to fit within the slot 10 of the grinding wheel 4. Advantageously, the keeper block 12 and tooth 2 move together relative to the slot 10 provided within the grinding wheel 4. Advantageously, the attachment of the keeper block of the present invention to the tooth by means of a bolt allows for a shorter bolt to be used than in previous assemblies.

In this embodiment, the tooth 2 comprises a main body 28 including a slot comprising two substantially planar 20 surfaces for, in use, engaging with the keeper block 12. The tooth 2 comprises one or more cutting face 31 connected to and extending away from the main body, wherein the cutting face includes one or more tips 31. In the embodiment wherein the tooth 2 comprises two or more tips 31, the tips may be perpendicular to each other. In another embodiment, the multi-tipped tooth may have protruding transverse tips to facilitate lateral grinding, in addition to radial tips. Such a multi-tipped tooth allows for cutting in radial and lateral dimensions simultaneously. The tips 31 may comprise a carbide material.

Advantageously, the tooth 2 may comprise a region 17 comprising replaceable components to prevent wear of the wheel.

Advantageously, only one tool 21 is required to drill the bolt into the keeper block and tooth, as shown in FIG. 11. One end 22 of the tool typically has an 8 mm hex head which fits into the M10 bolt head for tightening. The other end 23 of the tool is typically tapped to M12. This is used for extracting the keeper block. Once the bolt has been removed, the threaded end screws into the keeper block and bottoms out on the back of the tooth. Continuing to wind the thread in will push the keeper block out. Then the tooth can be removed freely. This is in contrast with previous systems where two tools are typically required, an allen key and a hammer. In previous systems, the hammer is used to knock the tooth out of the slot after the bolt has been removed.

During rotation, the wheel 4 absorbs a substantial proportion of the forces in the plane of the grinding wheel resulting from the grinding action. The locking mechanism of the invention assists in retaining the tooth 2 in place within the slot 10 as the grinding wheel 4 rotates.

Thus, in the above embodiments, the tooth comprises one or more cutter tips, a spigot in the underside of the channel which locates in a recess provided within a slot of the wheel, a tapered channel on the upper side of the tooth, and/or a threaded section at the back of the tooth. The keeper block is tapered on the underside and/or comprises a counter-bored hole from the front to the back.

In the embodiment of FIG. 12, in use, the spigot 8 may be provided on the wheel 4 and the recess 6 may be provided on the tooth 2. The keeper block 12 comprises a tapered surface which slides into a tapered channel provided on an upper surface of the tooth 2. The bolt 15 preferably passes through the keeper block 12 and screws into the back of the tooth 2. As the keeper block 12 is pulled in, it typically pushes the spigot 8 on the underside of the tooth 2 firmly into the recess 6 in the wheel 4 and locks the assembly tightly in place. Thus, in this embodiment, the tooth 2 is held securely within the wheel 4.

1. A tooth assembly for use in a grinding wheel, the tooth assembly comprising a holder for holding at least one tooth within a slot of the grinding wheel, wherein the at least one tooth comprises a tooth body, wherein the at least one tooth is removably attached to the holder by attachment means comprising a recess within the tooth body and a fixing receivable in the recess.

2. The tooth assembly according to claim 1, wherein the tooth body is removably attached to the holder.

3. The tooth assembly according to claim 1, wherein the fixing receivable in the recess is a bolt.

4. The tooth assembly according to claim 1, wherein the bolt is fitted into the recess within the tooth body.

5. The tooth assembly according to claim 1, wherein the recess within the tooth body comprises an internal thread that is complimentary to a thread provided on a post of the bolt.

6. The tooth assembly according to claim 1, wherein the holder comprises at least one region for accommodating the at least one tooth body.

7. The tooth assembly according to claim 1, wherein the region of the holder for accommodating the at least one tooth body comprises a through hole and wherein the head of the bolt is receivable within the through hole.

8. The tooth assembly according to claim 7, wherein
the through hole is counter bored to partially conceal the bolt head.

9. The tooth assembly according to claim 7, wherein an inner surface of the through hole comprises at least one substantially flat portion, and wherein a portion of the outer surface of the tooth body comprises at least one substantially flat surface.

10. The tooth assembly according to claim 9, wherein, in use, the tooth body is located within the through hole of the holder by locating the at least one substantially flat surface of the tooth body against the at least one substantially flat surface of the through hole.

11. The tooth assembly according to claim 1, wherein an aperture is provided within the head of the bolt to accommodate an allen key or other means for assisting with the reversible attachment of the bolt to the tooth body.

12. The tooth assembly according to claim 1, wherein the holder comprises an alloy steel.

13. The tooth assembly according to claim 1, wherein the tooth body comprises an alloy steel.

14. The tooth assembly according to claim 1, wherein the tooth further comprises at least one cutting face.

15. The tooth assembly according to claim 1, wherein the at least one cutting face comprises at least one tip.

16. The tooth assembly according to claim 1, wherein the at least one tip is soldered to the tooth body.

17. The tooth assembly according to claim 1, wherein the at least one tip comprises a tungsten carbide material.

18. The tooth assembly according to claim 1, wherein the at least one cutting face is circular in shape and comprises a circular outer surface.

19. The tooth assembly according to claim 1, wherein the tooth comprises a blind bore.

20. The tooth assembly according to claim 19, wherein the tooth body comprises the blind bore.

21. The tooth assembly according to claim 19, wherein the tip comprises the blind bore.

22. The tooth assembly according to claim 19, wherein the tooth body and tip provide the blind bore, wherein the tip acts as a closure means to the recess provided within the tooth body to provide the blind bore.

23. The tooth assembly according to claim 14, wherein, in use, the outer and front surface of the cutting face is exposed during cutting and thus becomes worn more quickly than the other sections of the cutting face, and wherein, when a portion of the exposed section of the cutting face becomes worn and loses its sharpness, the user may rotate the tooth body within the holder such that one of the other sections of the cutting face is at the outer and front position.

24. A grinding wheel comprising the tooth assembly according to claim 1.

25. A cutting apparatus comprising the grinding wheel according to claim 24.

26. A method of engaging at least one tooth with the grinding wheel according claim 24, comprising a step of removably attaching the at least one tooth to the holder by the attachment means comprising the recess within the tooth body and the fixing receivable in the recess.
